(19) United States
(12) Patent Application Publication
(10) Pub. No.: US 2012/0037322 A1
(43) Pub. Date: Feb. 16, 2012

(54) WINDOW BLIND CONTROL

(76) Inventor: Ronald K. Aselton, Gainesville, FL (US)

(21) Appl. No.: 12/853,418

(22) Filed: Aug. 10, 2010

(51) Int. Cl. E06B 9/30

(52) U.S. Cl. 160/168.1 R

(57) ABSTRACT

Disclosed is a blind slat control device that includes a first blind string passageway and a second blind string passageway oppositely disposed from the first blind string passageway. The blind string passageways are operable for a blind string to fit at least partially within and pass therethrough. Both the first and second blind string passageways have an entry end and an exit end. The entry ends of the blind string passageways are spaced apart by a first distance that is greater than a second distance between the exit ends. With the blind slat control device inserted between two adjacent slats in a window blind, slats within one section of the window blind can be in a generally open position while slats in a different section of the window blind can be in a generally closed position.

### FIELD OF THE INVENTION

This invention relates generally to window blinds. More specifically, the invention relates to a device for control of window blinds.

### BACKGROUND OF THE INVENTION

A window blind is a covering for a window that can be attached to the interior side of the window and hides or reduces the amount of sunlight that passes therethrough. In addition, window blinds can limit what can be viewed out through the window and likewise within in through the window. Slat blinds consist of a plurality of horizontal slats, usually made of metal or vinyl, which are connected with string in such a way that the slats can be rotated or tilted in order to allow, or not allow, light to pass between the slats. Most slat blinds afford for the slats to rotate up to 170 degrees in order to hide or allow light therethrough, or the slats can be pulled up altogether so that the entire window is clear. The slats can be tilted by rotating a small knob that is attached to the strings, by twisting a long wand or by pulling a cord.

Most slat blinds include slats that are bounded on each side by a string. When the slats are in a generally open position as illustrated in FIG. 1A, the distance between the pair of strings that bound the slats is relatively wide as shown in FIG. 1B as compared to the distance between the pair of strings when the slats are in a closed position (see FIGS. 2A and 2B). Thus by reducing the distance between the pair of strings bounding the slats, the slats are forced into a closed position.

The degree to which the slats are closed or open can be varied such that the slats are in a generally horizontal position or in a generally vertical position. In this manner, a user can adjust how much light enters in through a window with a wide degree of variation. However, the ability to have part of the slats in an open position and part of the slats in a closed position would be desirable. For example, the ability for a user to have the top portion of a window with slats in an open position and the bottom part of the window in a closed position such that someone cannot view within the window, would be desirable. Therefore, a window blind control device that affords for some of the slats in a window blind to be open while other slats are closed is needed.

### SUMMARY OF THE INVENTION

Disclosed is a blind slat control device that includes a first blind string passageway and a second blind string passageway oppositely disposed from the first blind string passageway. The blind string passageways are operable for a blind string to fit at least partially within and pass therethrough. Both the first and second blind string passageways have an entry end and an exit end. The entry ends of the blind string passageways are spaced apart by a first distance that is greater than a second distance between the exit ends. With the blind slat control device inserted between two adjacent slats in a window blind, slats within one section of the window blind can be in a generally open position while slats in a different section of the window blind can be in a generally closed position.

### BRIEF DESCRIPTION OF THE DRAWINGS

FIG. 1A is a perspective view of a slat blind in an open position;

FIG. 1B is a side view of the slat blind shown in FIG. 1A;

FIG. 2A is a perspective view of the slat blind in a closed position;

FIG. 2B is a side view of the slat blind shown in FIG. 2A;

FIG. 3 is a perspective view of an embodiment of the present invention;

FIG. 4 is a perspective view of the embodiment shown in FIG. 3;

FIG. 5 is a top view of the embodiment shown in FIG. 4; and

FIG. 6 is a front view of the embodiment shown in FIG. 4.

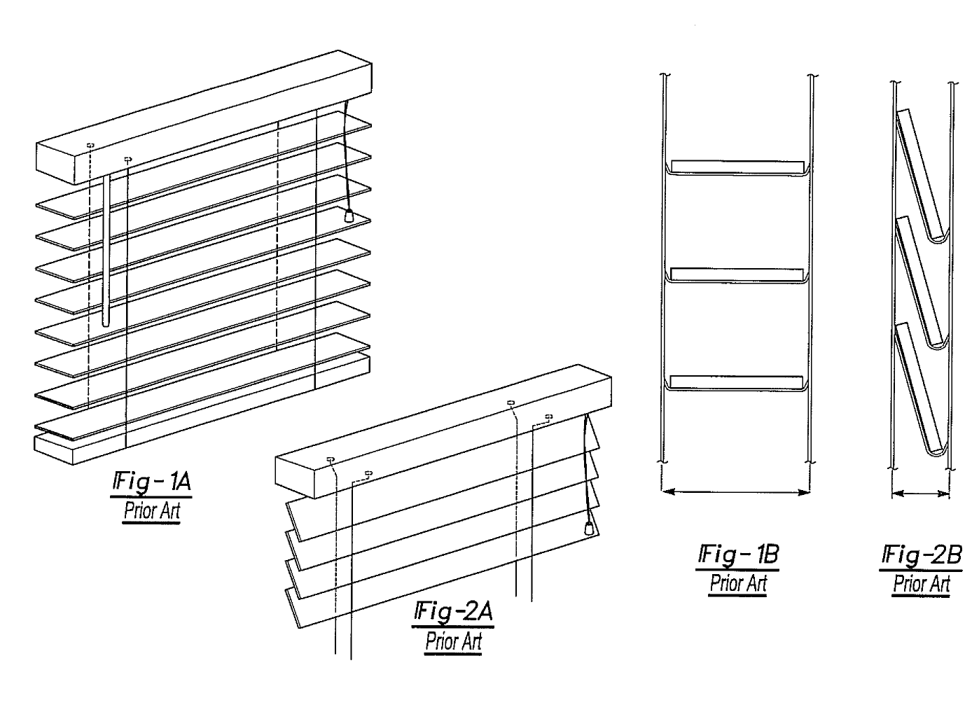

### DETAILED DESCRIPTION OF THE PREFERRED EMBODIMENTS

The present invention includes a simple to use blind slat control device that affords for slats within a window blind to be open within one section of the blind and closed within another section. As such, the present invention has utility as a window blind control device.

The window blind control device of the present invention is a body of material having a pair of blind string passageways operable for blind strings that bound the slats to pass therethrough. Each of the blind string passageways has an entry end proximate to a top surface of the device and an exit end spaced apart from the entry end and proximate a bottom surface of the device. The distance between the pair of entry ends of the blind string passageways is greater than the distance between the pair of exit ends. The greater distance between a pair of blind strings passing through the entry ends of the blind string passageways affords for slats located proximate to the top surface to be in an open position. The lesser distance between the pair of blind strings passing through the exit ends of the blind string passageways affords for slats proximate to the bottom surface to be in a closed position. The blind slat control device can be placed between slats in a window blind such that the slats on one side of the device can be controlled and placed in a different position than the slats on the other side of the device.

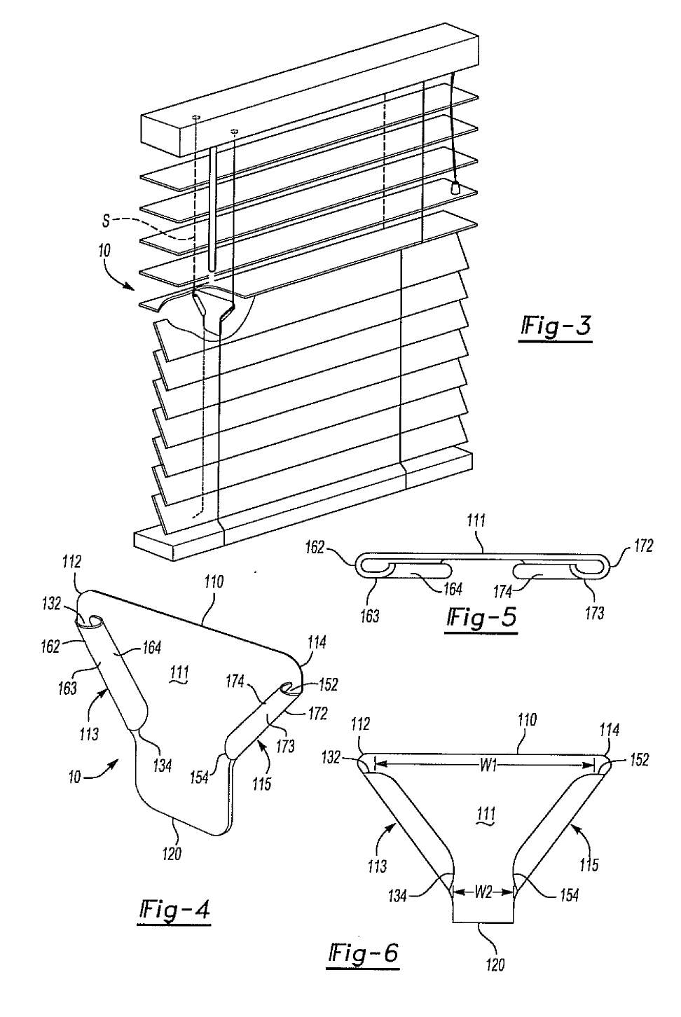

Referring now to FIGS. 3-6, an embodiment of the present invention is shown generally at reference numeral 10. The blind slat control device 10 includes a top surface 110 and a bottom surface 120. The top surface 110 has a first end 112 and a second end 114. At least partially between the first end 112 and the bottom surface 120 is a blind string passageway 113, with a matching blind string passageway 115 at least partially between the second end 114 and the bottom surface 120. In some instances, the blind string passageways 113 and 115 have a generally U-shape. In other instances, the blind string passageways have a partially enclosed U-shape. The blind string passageway 113 has an entry end 132 and an exit end 134, and the blind string passageway 115 has an entry end 152 and an exit end 154. The entry ends 132 and 152 are spaced apart by a width w1 and the exit ends 134 and 154 are spaced apart by a width w2. The width w1 is greater than the width w2.

In some instances, a sidewall 111 adjoins the first end 112 to the second end 114 of the top surface 110, and the top surface 110 to the bottom surface 120. The blind string passageways 113 and 115 are operable for a blind string S to pass therethrough. A blind string that is present on the window side of a window blind can pass through one of the blind string passageway and a blind string on the interior side of a window blind can pass through the other blind string passageway.

It is appreciated that the width dimension w1 between the blind entry ends 132 and 134 can be generally equal to the width of a blind slat and/or the distance between a pair of blind strings that bound blind slats when in a generally open position. It is also appreciated that the width dimension w2 between the exit ends 134 and 154 can be generally equal to a width that affords for slats located within blind strings passing through the blind string passageways 113 and 115 to be in a generally closed position. It is further appreciated that the blind slat control device 10 can be rotated 180 degrees such that the device 10 is placed within two slats of a slat blind with the top surface 110 positioned above the bottom surface 120. Thus by placing the blind slat control device 10 between two slats within a window blind and running a pair of blind strings bounding the window slats through the blind string passageways as described above, the blind slats proximate to the top surface 110 can remain in an open position while the blind slats proximate to the bottom surface 120 are placed in a closed position.

As illustrated in FIGS. 4 and 6, the main surface 111 can be generally funnel-shaped. Extending from the main surface 111 in a generally perpendicular direction can be a side surface 162 and a side surface 172. Extending from the side surface 162 and the side surface 172 in a generally perpendicular direction can be a flange surface 163 and a flange surface 173. The extension of the side surface 162 from the main surface 111 and the extension of the flange surface 163 from the side surface 162 forms a generally U-shaped structure. The same is true regarding the extension of the side surface 172 from the main surface 111 and the extension of the flange surface 173 from the side surface 172. In this manner, a generally U-shaped blind string passageway with an entry end and an exit end is afforded on the left-hand side of the blind slat control device 10 as viewed in FIG. 4. Likewise, a generally U-shaped blind string passageway with an entry end and an exit end is afforded on the right-hand side of the blind slat control device 10 as viewed in FIG. 4.

In some instances, the flange surfaces 163 and 173 can have extension surfaces 164 and 174 extending therefrom, respectively. The extension surfaces 164 and 174 afford for blind string passageways 113 and 115 with partially enclosed U-shaped structures.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

I claim:

1. A blind slat control device, said device comprising:
a first blind string passageway and a second blind string passageway oppositely disposed from said first blind string passageway, said blind string passageways operable for a blind string to fit at least partially within and pass therethrough;
said first blind string passage way having an entry end and an exit end spaced apart from said entry end;
said second blind string passage way having an entry end and an exit end spaced apart from said entry end;
said first blind string passageway entry end spaced apart from said second blind string passageway entry end by a first distance;
said first blind string passageway exit end spaced apart from said second blind string passageway exit end by a second distance, said first distance being greater than said second distance.

2. The blind control device of claim 1, further comprising a top surface proximate said entry ends and a bottom surface proximate said exit ends.

3. The blind control device of claim 2, further comprising a main surface adjoining said top surface with said bottom surface and said first blind string passageway with said second blind string passageway.

4. The blind control device of claim 3, wherein said main surface is generally funnel-shaped.

5. The blind control device of claim 1, wherein said first blind string passageway is generally U-shaped.

6. The blind control device of claim 5, wherein said generally U-shaped blind string passageway has a side surface extending in a generally perpendicular direction from said main surface and a flange surface extending in a generally perpendicular direction from said side surface.

7. The blind control device of claim 1, wherein said first blind string passageway is a partially enclosed U-shaped structure.

8. The blind control device of claim 7, wherein said partially enclosed U-shaped blind string passageway has a side surface extending in a generally perpendicular direction from said main surface, a flange surface extending in a generally perpendicular direction from said side surface and an extension surface extending from said flange surface.

9. A blind slat control device, said device comprising:
a main surface;
a first blind string passageway and a second blind string passageway extending from said main surface, said second blind passageway oppositely disposed from said first blind string passageway;
said first blind string passageway having an entry end and an exit end spaced apart from said entry end;
said second blind string passageway having an entry end and an exit end spaced apart from said entry end;
said first blind string passageway entry end spaced apart from said second blind string passageway entry end by a first distance;
said first blind string passageway exit end spaced apart from said second blind string passageway exit end by a second distance, said first distance being greater than said second distance.

10. The blind slat control device of claim 9, wherein said main surface has a top surface proximate said entry ends and a bottom surface proximate said exit ends.

11. The blind control device of claim 9, wherein said main surface is generally funnel-shaped.

12. The blind control device of claim 9, wherein said first blind string passageway is generally U-shaped.

13. The blind control device of claim 12, wherein said generally U-shaped blind string passageway has a side surface extending in a generally perpendicular direction from said main surface and a flange surface extending in a generally perpendicular direction from said side surface.

14. The blind control device of claim 9, wherein said first blind string passageway is a partially enclosed U-shaped structure.

15. The blind control device of claim 14, wherein said partially enclosed U-shaped blind string passageway has a side surface extending in a generally perpendicular direction from said main surface, a flange surface extending in a generally perpendicular direction from said side surface and an extension surface extending from said flange surface.

16. A blind slat control device, said device comprising:
a generally funnel-shaped main surface;
a first blind string passageway and a second blind string passageway extending from said main surface, said second blind passageway oppositely disposed from said first blind string passageway;
said first blind string passageway being generally U-shaped and having an entry end and an exit end spaced apart from said entry end;
said second blind string passageway being generally U-shaped and having an entry end and an exit end spaced apart from said entry end;
said first blind string passageway entry end spaced apart from said second blind string passageway entry end by a first distance;
said first blind string passageway exit end spaced apart from said second blind string passageway exit end by a second distance, said first distance being greater than said second distance.

17. The blind control device of claim 16, wherein said generally U-shaped blind string passageways have a side surface extending in a generally perpendicular direction from said main surface and a flange surface extending in a generally perpendicular direction from said side surface.
